(19) United States
(12) Patent Application Publication
(10) Pub. No.: US 2013/0080896 A1
(43) Pub. Date: Mar. 28, 2013

(54) EDITING SYSTEM FOR PRODUCING PERSONAL VIDEOS

(71) Applicant: Yi-Lin CHEN, Taichung City (TW)

(72) Inventor: Yi-Lin CHEN, Taichung City (TW)

(21) Appl. No.: 13/247,447

(22) Filed: Sep. 28, 2011

(51) Int. Cl. G06F 3/048

(52) U.S. Cl. 715/723

(57) ABSTRACT

An editing system for producing personal video comprises a processing unit, a music database, a display unit, a human-machine interface and an output unit, wherein the processing unit can be provided for logic computation, notating digital photos and editing the digital photos. The music database is preset with a plurality of music files, and each music file is defined with a plurality of melody regions in accordance with its melodies. The processing unit combines the digital photos having different notations with each melody region of the music file for broadcasting or expression via multimedia special effect.

### BACKGROUND OF THE INVENTION

1. Field of the Invention

The present invention relates to a digital photo editing system, and more particularly to an editing system for producing personal videos.

2. Description of the Related Art

A photo is a silent language, an invisible script. With the unique photo recording memories, image having happiness and memories on the photo can be retained for a long period. However, each user has different music preferences, and melody, rhythm and required feeling of each song are further different. Each person must effectively store and classify many photos to allow photo arrangement with diversity of subjects to have various specifications so that the user can arrange the photos in accordance with photo subjects or different topics. Moreover, the user can use contrasts, such as illustrations, stickers or entrances tickets, tickets, scripts, and personal letters, to increase the remaining value of these photos.

Recently, although digital image technique is gradually mature, static image remaining is main force. Similar editing software, such as VideoStudio® and PowerDirector® exists on the market, and the foregoing editing software for digital photos may cause difficulty in learning while editing these digital photos into slides. The user must firstly arrange and regulate the digital photos and music during the slide production and then slowly and gradually edits the digital photos at precision time. While replacing music, the foregoing steps must start all over again. Meanwhile, video arrangement is pretty tough, and a shortcoming of being unable to easily produce the digital photos into display in accordance with music melody needs to be overcome

### SUMMARY OF THE INVENTION

In view of the shortcomings of the prior art, the inventor(s) of the present invention based on years of experience in the related industry to conduct extensive researches and experiments, and finally developed an editing system for producing personal video as a principle objective to support an user to rapidly produce a personal MV video capable of automatically switching digital photos in accordance with music melody.

To achieve the foregoing objective of the invention, an editing system for producing personal video is provided and comprises a processing unit for performing logic computation, notating digital photos and storing the digital photos, the processing unit built with design software capable of arranging inner page formats and editing the digital photos; a music database connected to the processing unit, the music database preset with a plurality of music files, and each music file defined with a plurality of melody regions in accordance with music melody, the processing unit combining the digital photos having different notations with each melody region of one of the music files for broadcasting; a display unit connected to the processing unit, the display unit having functions of displaying an operation screen of the design software contained in the processing unit; a human-machine interface connected to the processing unit, the human-machine interface having functions of operating the processing unit and the design software; and an output unit connected to the processing unit, the output unit having functions of outputting arranged digital photos and the music files.

### BRIEF DESCRIPTION OF THE DRAWINGS

FIG. 1 is a structural diagram of the invention;

FIG. 2 is a schematic diagram of using status in self-subscribing inner page format according to the invention;

FIG. 3 is a schematic diagram of using status in self-editing digital photos according to the invention;

FIG. 4 is a schematic diagram of processing flow according to a the invention;

FIG. 5 is a schematic diagram of using status in selecting inner page format according to the invention;

FIG. 6 is a schematic diagram of using status in starting pick window of photos according to the invention;

FIG. 7 is a schematic diagram of completing photo taking according to the invention;

FIG. 8 is a display schematic diagram of allowing a display unit to select music files according to the invention;

### DETAILED DESCRIPTION OF THE PREFERRED EMBODIMENTS

The foregoing and other technical characteristics of the present invention will become apparent with the detailed description of the preferred embodiments and the illustration of the related drawings.

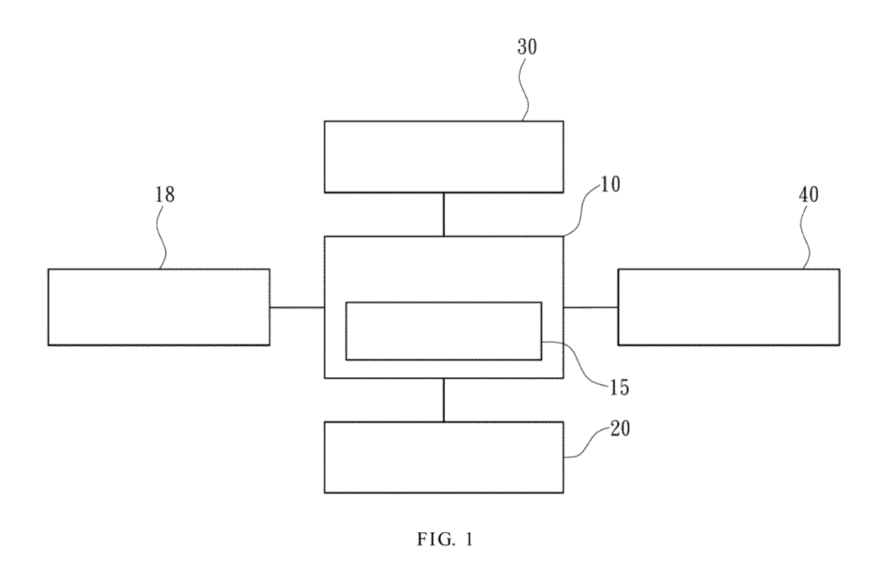

The invention is used for providing an editing system for producing personal videos, and more particularly to an editing system for automatically switching digital photos in accordance with different melodies of each music file. As shown in FIG. 1, the system mainly comprises a processing unit 10, a music database 18, a display unit 20, a human-machine interface 30 and an output unit 40.

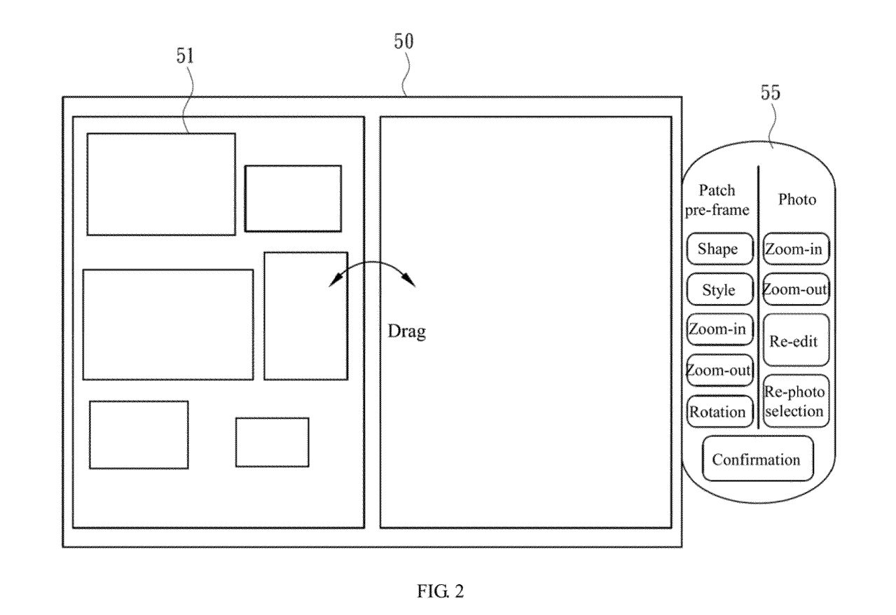

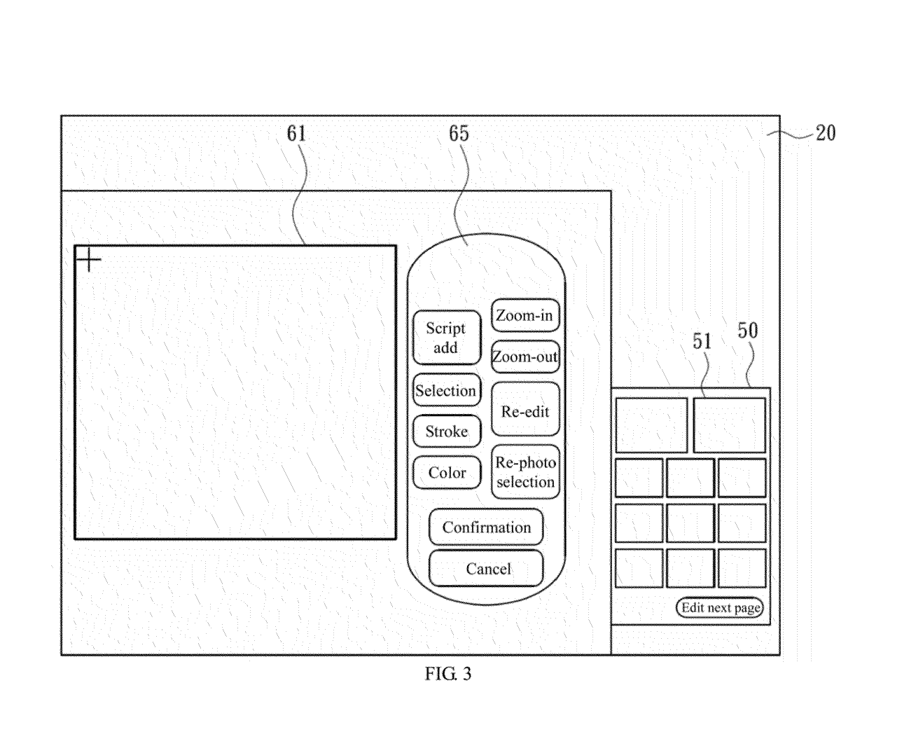

The processing unit 10 can be equipment, such as a remote server, a computer, a cell phone, for transmitting information through wire or wireless ways. The processing unit 10 can perform logic computation, digital photos notation and store the digital photos. The processing unit 10 is built with design software 15. The design software 15 can be used for arranging and storing different inner page format samples of photo albums and controls the shape, zoom-in, zoom-out, rotation or dragging for the photo frame in the inner page format (as shown in FIG. 2). The design software 15 further edits the digital photos and can control the zoom-in, zoom-out, script increasing/deleting, strokes, partial capture, background regulation or coloring (as shown in FIG. 3).

The music database 18 is connected to the processing unit 10. The music database 10 is preset with many music files, and each music file is defined with many melody regions in accordance with music melody. The processing unit 10 can combine the digital photos having different notations with each melody region of one of the music files for broadcasting and decides the broadcast sequence and time of the digital photos in accordance with the melody region of each music file.

The display unit 20 is connected to the processing unit 10. The display unit 20 can display an operation screen, digital photos, editing, arrangement processing of the design software 15 contained by the processing unit 10. The processing unit 20 can be a liquid crystal display, a plasma display, a smart phone, and a touch screen.

The human-machine interface 30 is connected to the processing unit 10. The user can operate each function of the design software 15 of the processing unit 10 through the human-machine interface 30. The human-machine interface 30 can be a keyboard, a mouse, and a touch display.

The output unit 40 is connected to the processing unit 10. The output unit 40 is used for combining the edited inner page format of the photo album and the digital photos with music files to output and can be storage equipment, a liquid crystal display, a plasma display, a smart phone, a touch display, and display equipment of network remote storage.

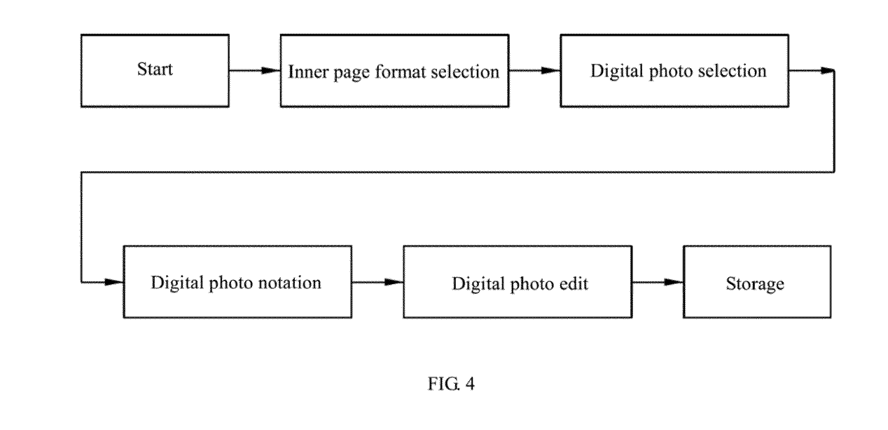

With reference to FIG. 4, with the foregoing system configuration, the user can complete personal video editing work through a starting step, a step of selecting inner page formats, a step of selecting digital photos, a step of notating digital photos, a step of editing digital photos and a storing step.

The starting step is that taken digital photos are uploaded to specific addresses inside the processing unit 10 in advance before starting. Next, the design software 15 in the processing unit 10 is activated. To enhance data security, the starting of the design software 15 can be designed with a safety protection program that can be logged-in via accounts and passwords or biological characteristic inputs.

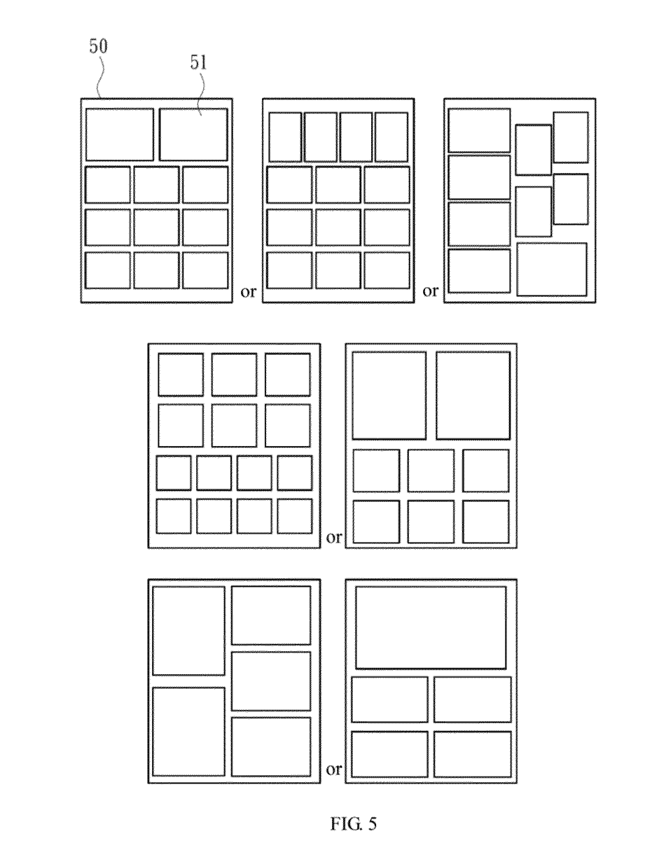

The step of selecting inner page formats is that the human-machine interface 30 is utilized to select the inner page formats 50 (as shown in FIG. 5) of the photo album to be used after starting the design software 15. The inner page formats 50 can be a sample set by inner pages. The inner page formats 50 have one or more patch pre-frames 51 provided for pasting photos. Alternatively, as shown in FIG. 2, the patch pre-frame 51 can be self-set by the user. The self-set inner page format 50 is to additionally start an inner page editing control member 55. The inner page editing control member 55 can control arrangement functions of the position, the shape, zoom-out, zoom-in, rotation or dragging for the patch pre-frames 51.

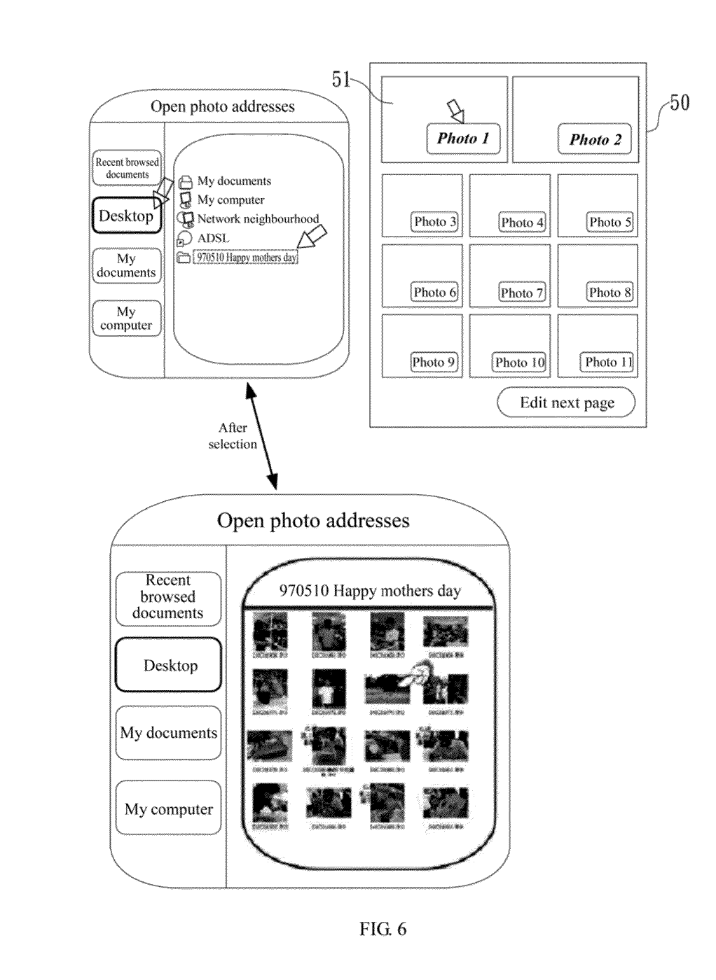

The step of selecting digital photos is that after completing the selection of the inner page format 50, any patch pre-frame 51 of the inner page format 50 is pressed by the human-machine interface 30 as shown in FIG. 6 to start a photo selection window such that the user can paste the corresponding digital photo to the patch pre-frames, and the selected digital photos can be automatically regulated and recorded to match the size of the patch pre-frame 51. The dimension having the same size can be obtained while displaying the digital photos. Further, the selected digital photos are also marked to allow the user to confirm whether or not the digital photo needs to be repeatedly arranged in the same photo album.

The step of notating digital photos is that when the user pastes the digital photo to the patch pre-frame 51, the processing unit 10 respectively gives different broadcast notations of addresses and classes in accordance with the shape and the size of each patch pre-frame 51 pasted with the digital photo. The notation of each digital photo can respectively correspond to the melody regions of the music files that are preset in the music database 18 and further decide the broadcast sequence and time of the digital photos.

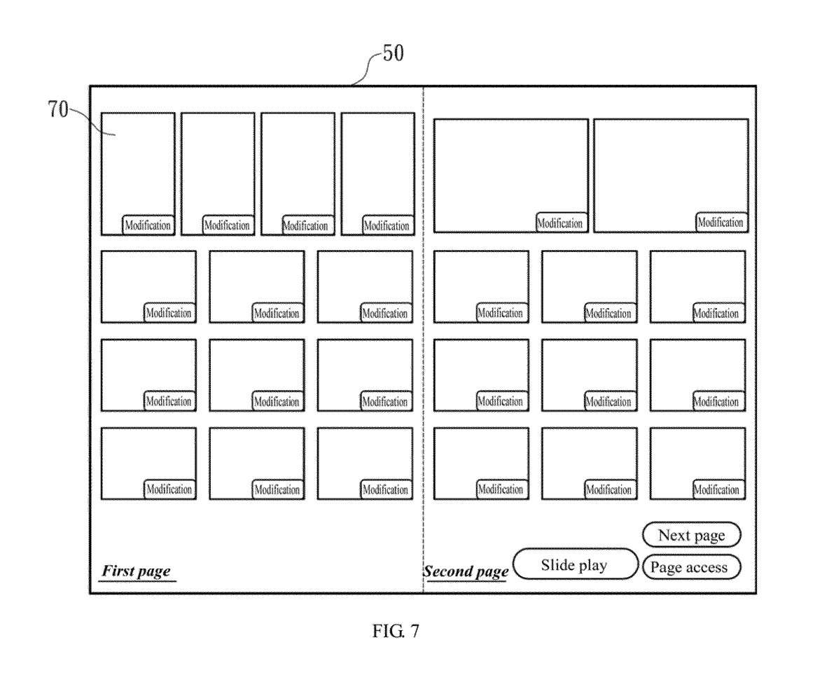

The step of editing digital photos is that after completing the selection of digital photos as shown in FIG. 3, the digital photo pasted to the patch pre-frame 51 of the inner page format 50 is selected through the human-machine interface 30 to start a photo editing control member 65. The photo editing control member 65 can operate zoom-in, zoom-out, script increasing/deleting, strokes, partial capture, background regulation or coloring with respect to the digital photo. A capturing pre-frame 61 is then utilized to capture required parts from the digital photo to allow the capture part to fully fill with the patch pre-frame 51 of the original inner page format 50 so as to form taken pictures as shown in FIG. 7.

The storing step is that after completing the editing of the digital photo in the inner page format 50, the inner page format 50, which has been completely arranged, is stored.

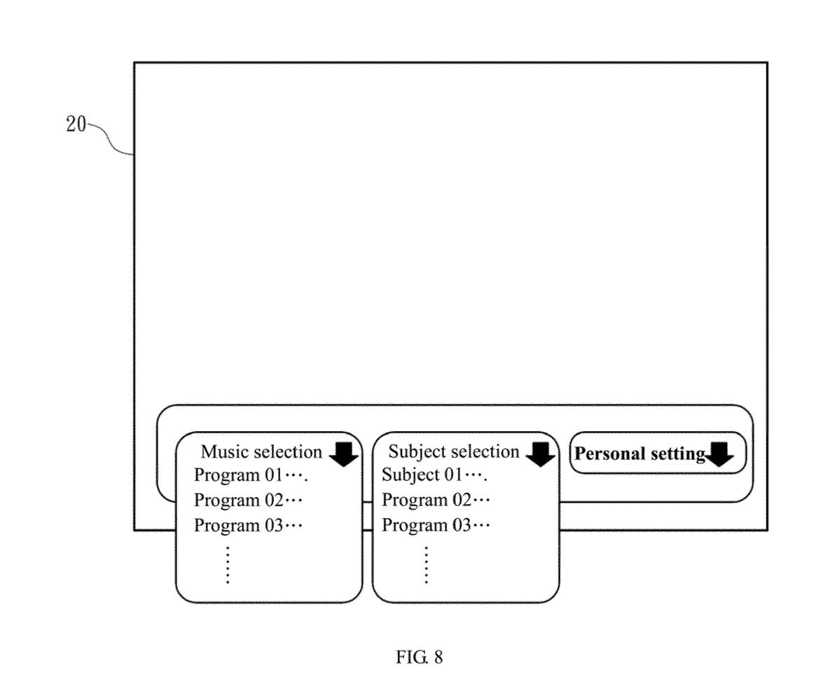

With the foregoing editing step, the processing unit 10 gives different notations respectively when the user pastes the digital photos to the patch pre-frame 51. The processing unit 10 gives different notations respectively based upon the shape and the size of each patch pre-frame 51 pasted with the digital photo so as to decide the sequence and time of broadcasting the music file in the future. Further, the user can simply and rapidly produce personal MV video of automatically switching digital photos in accordance with music melodies. Afterward once the copyright of the music file is obtained to perform postproduction, the user can select the file to complete the personal MV video through the system. In accordance with each different melody region of each music file, while selecting and broadcasting different music files (as shown in FIG. 8) on the display unit 20, the digital photo may also express different broadcast styles.

It should be noted that the processing unit 10 can randomly broadcast digital photos having different notations in accordance with the melody region of each music file so that the broadcast style of the digital photos can be varied.

After completing the foregoing steps, the inner page format, which has been arranged, can be provided for any remote user to watch the entire personal MV video that had been arranged through the output unit 40.

Moreover, with the editing system for producing personal video and production steps of the invention, illustrations, scripts, personal letters and photos are further used to serve as a contrast. Alternatively, music captions, multimedia special effect, video contained in the music file are displayed during the broadcast of music files so that digital photos can be broadcasted under the multimedia special effect contained in the music file or the video, and an unique personal MV video can be produced to allow the user to easily and simply combine the inner page format and the digital photos with user's thinking and mind, and furthermore preferable music is incorporated to develop personal video with unlimited imagination space to provide the user to quickly create personal MV matching personal thinking.

The invention improves over the prior art and complies with patent application requirements, and thus is duly filed for patent application. While the invention has been described by device of specific embodiments, numerous modifications and variations could be made thereto by those generally skilled in the art without departing from the scope and spirit of the invention set forth in the claims.

What is claimed is:

1. An editing system for producing personal video comprising:
a processing unit for performing logic computation, notating digital photos and storing the digital photos, the processing unit built with design software capable of arranging inner page formats and editing the digital photos;
a music database connected to the processing unit, the music database preset with a plurality of music files, and each music file defined with a plurality of melody regions in accordance with music melody, the processing unit combining the digital photos having different notations with each melody region of one of the music files for broadcasting;
a display unit connected to the processing unit, the display unit having functions of displaying an operation screen of the design software contained in the processing unit;
a human-machine interface connected to the processing unit, the human-machine interface having functions of operating the processing unit and the design software; and
an output unit connected to the processing unit, the output unit having functions of outputting arranged digital photos and the music files.

2. The editing system for producing personal video as recited in claim 1, wherein the processing unit decides broadcast sequence and time of the digital photos in accordance with the melody region of each music file.

3. The editing system for producing personal video as recited in claim 2, wherein an user completes production of personal MV video through steps of starting, selecting inner page formats, selecting the digital photos, notating the digital photos, editing the digital photos and storing by using the processing unit, the music database, the display unit, the human-machine interface and the output unit.

4. The editing system for producing personal video as recited in claim 3, wherein the step of notating the digital photos is that after the user selects the digital photos, the processing unit gives a broadcasting notation of different addresses and classes respectively in accordance with the inner page format pasted with the digital photos, and the notation of each digital photo can correspond to the melody region of the preset music files in the music database to further decide the broadcast sequence and time of the digital photos.

5. The editing system for producing personal video as recited in claim 1, wherein the processing unit randomly selects broadcasting the digital photos having different notations in accordance with the melody region of each music file.

6. The editing system for producing personal video as recited in claim 1, wherein the processing unit is one of a computer, a wireless network, a smart phone or a digital camera.

7. The editing system for producing personal video as recited in claim 1, wherein the display unit is one of a liquid crystal display, a plasma display, a smart phone or a touch display.

8. The editing system for producing personal video as recited in claim 1, wherein the human-machine interface is one of a keyboard, a mouse or a touch display.

9. The editing system for producing personal video as recited in claim 1, wherein the output unit is one of storage equipment, a liquid crystal display, a plasma display, a smart phone, a touch display, remote network storage or display equipment

10. The editing system for producing personal video as recited in claim 1, wherein the design software further has a safety protection program that is logged-in via accounts and passwords or biological characteristic.
